(19) United States
(12) Patent Application Publication
(10) Pub. No.: US 2022/0138533 A1
(43) Pub. Date: May 5, 2022

(54) COMPUTER-IMPLEMENTED METHOD FOR DETERMINING CRITICALITY VALUES OF A TECHNICAL SYSTEM

(71) Applicant: Robert Bosch GmbH, Stuttgart (DE)

(72) Inventors: Peter Bakucz, Klosterlechfeld (DE); Javier Bores, Vaihingen-Kleinglattbach (DE)

(21) Appl. No.: 17/449,733

(22) Filed: Oct. 1, 2021

(30) Foreign Application Priority Data
Nov. 4, 2020 (DE) 102020213888.5

(51) Int. Cl. G06N 3/04; G06N 3/10; G06N 5/00; G06N 5/04; G06F 30/27

(52) U.S. Cl. CPC G06N 3/0436; G06N 3/10; G06F 2119/02; G06N 5/048; G06F 30/27; G06N 5/003

(57) ABSTRACT

A computer-implemented method for determining criticality values of a technical system. The method includes: specifying a reliability of the technical system that is to be satisfied; providing a fuzzy fault tree for the technical system, the fuzzy fault tree comprising a fuzzy top event and multiple fuzzy basic events and logical programmable fuzzy AND/OR operators; transforming the fuzzy fault tree into a flexible neural network comprising a tree structure; determining an optimized flexible neural network by carrying out a learning method for optimizing the flexible neural network, the optimized flexible neural network achieving the reliability of the technical system that is to be satisfied; deriving criticality values of the fuzzy basic events from the optimized flexible neural network.

### CROSS REFERENCE

The present application claims the benefit under 35 U.S.C. § 119 of German Patent Application No. DE 102020213888.5 filed on Nov. 4, 2020, which is expressly incorporated herein by reference in its entirety.

### FIELD

The present invention relates to a computer-implemented method for determining criticality values of a technical system.

The technical system is in particular software, hardware or an embedded system. The technical system comprises a plurality of components, in particular technical components.

### BACKGROUND INFORMATION

For analyzing technical systems, fault tree analysis (FTA) is a conventional method for analyzing the fault logic of a system and for calculating the overall reliability.

The fault tree analysis starts from a single undesired event, which stands at the top of the fault tree, the so-called top event, which describes for example the total failure of the system and is ascertained within the scope of a risk analysis.

Starting from this top event, the fault tree is produced in a top-down analysis down to the individual failure states of the components. More complex systems are divided into subsystems, which are analogously divided further until the complete system is mapped in the form of minimal cut sets that cannot be divided further in the form of basic events. The failure combinations in the fault tree are logically combined using Boolean algebra and its symbols, in particular AND and OR.

In the simplest case, components of a system, which depend on one another for their proper functioning, are combined by the logical OR function. In this case, the failure of one component already results in a failure of the entire system. Components that are able to replace one another reciprocally (redundancy) are combined by the AND function in the fault tree.

By way of the fuzzy membership function of the basic events, it is possible to specify in particular a fuzziness of the occurrence of the basic events gradually via numerical values between 0 and 1. By way of the fuzziness properties, it is not possible to determine criticality values, in particular of redundant basic events, using hitherto conventional methods.

An object to the present invention is to achieve this objective.

### SUMMARY

One specific example embodiment of the present invention relates to a computer-implemented method for determining criticality values of a technical system, the method comprising the following steps:

specifying a reliability of the technical system that is to be satisfied;

providing a fuzzy fault tree for the technical system, the fuzzy fault tree comprising a fuzzy top event and multiple fuzzy basic events and logical, programmable fuzzy AND/OR operators; transforming the fuzzy fault tree into a flexible neural network comprising a tree structure;

determining an optimized flexible neural network by carrying out a learning method for optimizing the flexible neural network, the optimized flexible neural network achieving the reliability of the technical system that is to be satisfied;

deriving criticality values of the fuzzy basic events from the optimized flexible neural network.

When transforming the fuzzy fault tree, the fuzzy membership functions of the basic events and the linkages between the individual basic events are translated into neurons of the neural network.

The logical, programmable AND/OR operators are interpreted as redundancy functions. Via the logical, programmable AND/OR operators, expanded redundancy functions, in particular hot redundancy and cold redundancy, may be taken into account.

Due to the tree structure, the flexible neural network has a forward-directed, or, regarded as a tree structure, an upward-directed hierarchical structure, that is, it is a feedforward neural network. Within the network, information is always transmitted only in one direction. There exist no feedback loops between neurons of the same or preceding layers.

Flexible means in this case that neurons may repeat in different layers of the flexible neural network.

By way of the method according to an example embodiment of the present invention, criticality values of the basic events are thus determined on the basis of the entire fuzzy fault tree. The structure of the fuzzy fault tree influences the distribution of a respective basic event in the flexible neural network.

According to one specific example embodiment of the present invention, the learning method comprises a first level for optimizing the structure of the flexible neural network. When optimizing the structure, the arrangement of the neurons in the flexible neural network, in particular the position and/or number of neurons, is changed.

According to one specific example embodiment of the present invention, it is provided that an optimization is determined on the basis of a fitness function of fuzzy redundancy functions of the fuzzy fault tree. The fitness function may be calculated for example via the mean squared error MSE or via the root mean squared error RMSE.

According to one specific example embodiment of the present invention, the learning method comprises a second level for optimizing parameters of the fuzzy membership functions.

According to one specific example embodiment of the present invention, it is provided that at least one step of the learning method, in particular steps for optimizing the structure of the neural network and/or steps for optimizing parameters of the fuzzy membership functions, are based on a heuristic method, in particular a simulated annealing method. Advantageously, this is an embedded simulated annealing method. This makes it possible to investigate the criticality in an embedded environment, in which other conventional methods do not work. For example, the microcontroller environment of a control unit is not able to work at the fuzzy fault tree analysis level. For this reason, the conversion into a flexible neural network is proposed. Advantageously, both the steps for optimizing the structure of the neural network and the steps for optimizing parameters of the fuzzy membership functions are performed by an embedded simulated annealing method. It is thus provided that both the first level of the learning method for optimizing the structure of the flexible neural network as well as the second level of the learning method for optimizing parameters of the fuzzy membership functions of the learning method occur via an embedded simulated annealing method.

According to one specific example embodiment of the present invention, it is provided that steps for optimizing parameters of the fuzzy membership functions comprise the execution of an optimization algorithm.

According to one specific example embodiment of the present invention, it is provided that the optimization of the structure of the flexible neural network and/or the optimization of the parameters of the membership function are executed repeatedly until a termination criterion is fulfilled.

According to one specific example embodiment of the present invention, it is provided that the termination criterion is given by reaching or exceeding a specific number of iterations or by the expiration of a specifiable period of time or by reaching an optimization.

According to one specific example embodiment of the present invention, it is provided that the optimization of the structure of the flexible neural network and the optimization of parameters of the fuzzy membership functions are executed repeatedly in alternation. Advantageously, the learning method is executed until an optimized flexible neural network has been determined.

According to one specific example embodiment of the present invention, it is provided that the derivation of criticality values of the fuzzy basic events from the optimized flexible neural network occurs on the basis of the number of the fuzzy basic events of the optimized flexible neural network normalized with the optimized parameter of the second level of the respective fuzzy basic event.

Further specific embodiments of the present invention relate to a computer program, the computer program comprising computer-readable instructions, a computer-implemented method according to the specific embodiments being carried out when the instructions are executed by a computer.

Further specific embodiments of the present invention relate to a use of a method according to the specific embodiments and/or of a computer program according to the specific embodiments in an embedded environment of a technical system for establishing and/or checking functionalities of the technical system.

Further specific embodiments of the present invention relate to a use of a method according to the specific embodiments and/or of a computer program according to the specific embodiments for developing a technical system.

Additional features, uses and advantages of the present invention result from the following description of exemplary embodiments of the present invention, which are shown in the figures. For this purpose, all of the described or represented features form the subject of the present invention, either alone or in any combination, irrespective of their combination, formulation or representation in the description or in the figures.

### BRIEF DESCRIPTION OF THE DRAWINGS

FIG. 1 shows a schematic illustration of aspects of a method for determining criticality values of a technical system, in accordance with an example embodiment of the present invention.

FIG. 2A shows a schematic illustration of aspects of a neural network, in accordance with an example embodiment of the present invention.

FIG. 2B shows a schematic illustration of further aspects of a neural network, in accordance with an example embodiment of the present invention.

FIG. 3 shows steps of a learning method for optimizing a neural network, in accordance with an example embodiment of the present invention.

### DETAILED DESCRIPTION OF EXAMPLE EMBODIMENTS

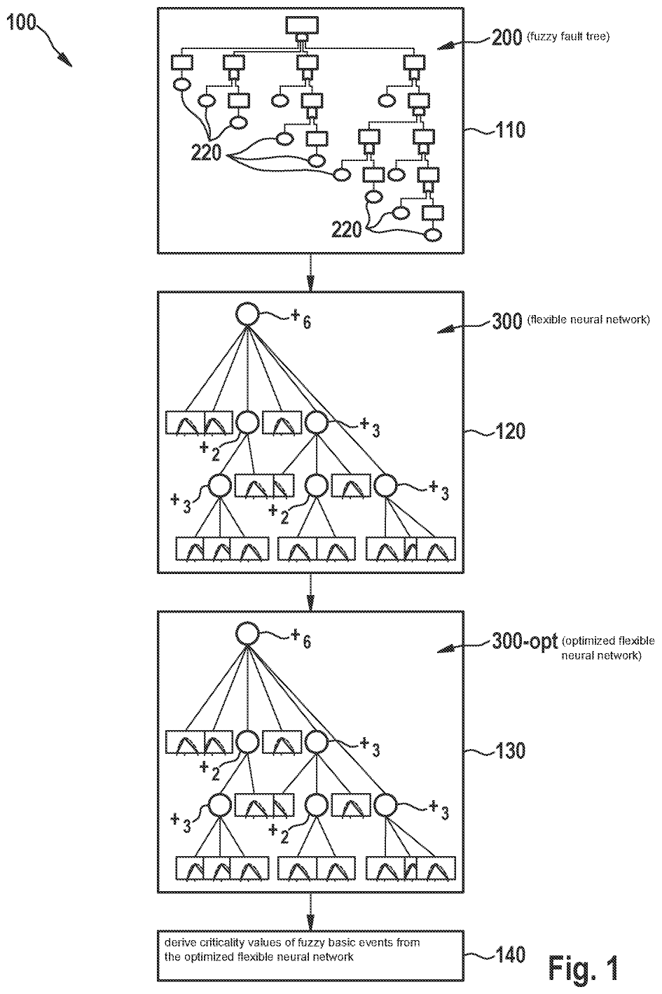

FIG. 1 shows a schematic illustration of aspects of a method 100 for determining criticality values of a technical system.

The technical system is in particular software, hardware or an embedded system. The technical system comprises a plurality of components, in particular technical components.

Method 100 comprises a step for specifying a reliability of the technical system that is to be satisfied.

Method 100 comprises a step 110 for providing a fuzzy fault tree 200 for the technical system.

Fuzzy fault tree 200 is produced for example within the scope of a fault tree analysis of the technical system. An exemplary illustration of the fault tree is likewise shown in FIG. 1.

A fuzzy top event 210 is at the top of fuzzy fault tree 200. Fuzzy top event 210 represents an undesired event, for example the total failure of the technical system. Fuzzy top event 210 is ascertained for example within the scope of a risk analysis and is specified by requirements, which describe the standards concerning the reliability of the technical system.

By way of example, nine fuzzy basic events 220 are shown in FIG. 1. Linkages between fuzzy basic events 220 are represented by logical, programmable AND operators and/or by logical, programmable OR operators. Every fuzzy basic event 220 is represented by a fuzzy membership function.

The AND operators and OR operators are interpreted as redundancy functions.

Method 100 further comprises a step 120 for transforming fuzzy fault tree 200 into a flexible neural network 300 comprising a tree structure.

When transforming the fuzzy fault tree 200, the fuzzy membership functions of the basic events 220 and the linkages 230 between the individual basic events 220 are translated into neurons of flexible neural network 300.

The flexible neural network is thus based on a set F of fuzzy functions, the fuzzy functions comprising the redundancy functions of the logical, in particular programmable, AND/OR operators of fuzzy fault tree 200.

Furthermore, the flexible neural network is based on a set T of fuzzy terminal instructions, the fuzzy terminal instructions comprising the fuzzy membership functions of fuzzy fault tree 200.

A model S of the flexible neural network is mathematically given by

S=F∩_T,

where F={+₂;+₃; . . . ; +_{N}}designates the redundancy functions for inner nodes having i inputs of the flexible neural network, where i=2, N, and _T={x₁;x₂; . . . ; xₙ}designates instructions for input nodes having no further inputs of the neural network.

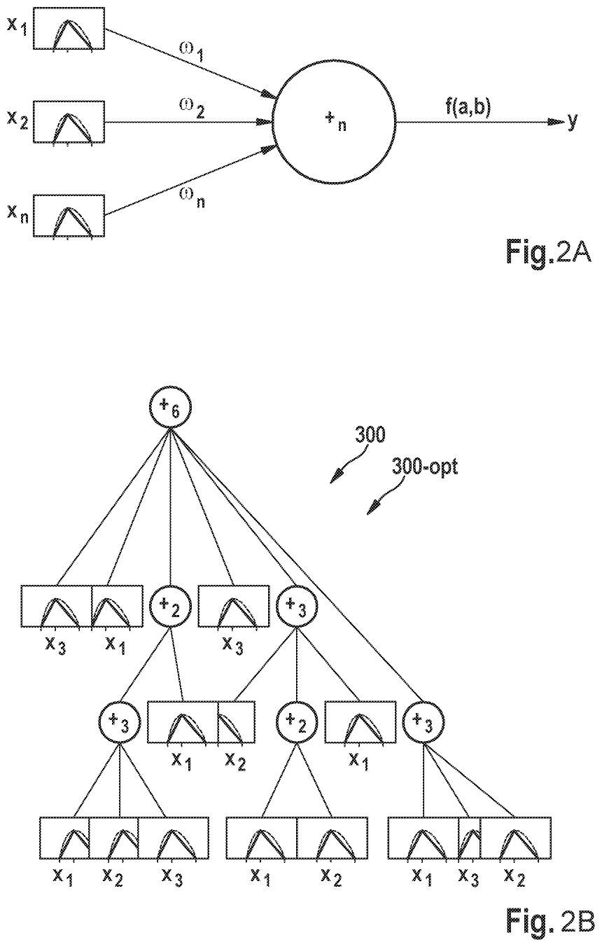

The structure of the flexible neural network is explained with reference to FIGS. 2A and 2B.

The function +ᵢ of an inner node is also called a flexible neuron operator having i inputs.

When producing the flexible neural network 300 by transforming 110 fuzzy fault tree 200, for a respective inner node, to which a function +ᵢ is assigned, the values for i are derived from the structure of fuzzy fault tree 200. The values for i illustrate the number of inputs of the respective inner nodes.

Furthermore, two adaptable parameters aᵢ and bᵢ are formed as parameters for a flexible activation function f, where f(ai,bi,x)=tan⁻¹((x−aᵢ)/(bᵢ)). The formation of parameters aᵢ and bᵢ occurs for example randomly by using the Monte Carlo method for a probability density function of the topology of fuzzy fault tree 200.

For the flexible neural network 300, usually a non-dynamic flexible activation function is used.

The input nodes are weighted via their edges with wⱼ. The influence of the input nodes on the inner nodes may thus be described via

$$n e {t}_{n} = {\sum }_{j = 1}^{n} {w}_{j} * {x}_{j} .$$

The output of an inner node may thus be described via

outₙ=f(aₙ,bₙ,netₙ).

FIG. 2B schematically shows a flexible neural network 300. The illustration in FIG. 2B exemplifies an optimized neural network 300-opt.

Method 100 further comprises a step 130 for determining an optimized flexible neural network 300-opt by carrying out a learning method for optimizing the flexible neural network, the optimized flexible neural network achieving the reliability of the technical system that is to be satisfied. The learning method comprises the optimization on two levels. On a first level, the structure of the flexible neural network is optimized. On a second level, the parameters of the fuzzy membership functions are optimized.

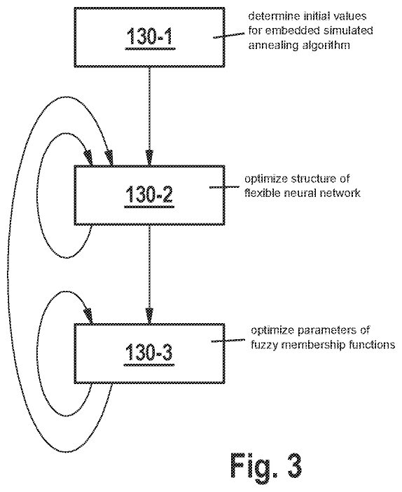

The learning method is explained below with reference to FIG. 3.

The learning method comprises an embedded simulated annealing algorithm. This makes it possible to investigate the criticality in an embedded environment, in which other conventional methods do not work. For example, the microcontroller environment of a control unit is not able to work at the fuzzy fault tree analysis level. For this reason, the conversion into a flexible neural network is proposed.

In a first step 130-1, the initial values are determined for the embedded simulated annealing algorithm.

In a step 130-2, the structure of the flexible neural network 300 is optimized by the embedded simulated annealing algorithm. When optimizing the structure, the arrangement of the neurons in the flexible neural network, in particular the position and/or number of neurons, is changed. The optimization is determined on the basis of the fitness functions of the fuzzy redundancy functions. The fitness function is calculated via the mean squared error MSE or via the root mean squared error RMSE with

$$MSE ( i ) = \frac{1}{P} {\sum }_{j = 1}^{P} {( {x}_{1}^{j} - {x}_{2}^{j} )}^{2} and \\ RMSE ( i ) = \sqrt{M S E ( i )} , \qquad$$

where P indicates the number of basic events and x₁^{j}, x₂^{j} indicate the current outputs of the flexible neural network.

Step 130-2 may be advantageously repeated until a termination criterion is reached. A termination criterion is for example the reaching of a maximum number of repetitions, the reaching of a number of repetitions in which no improved structure was found, or the discovery of an improved structure.

In a step 130-3, parameters of the fuzzy membership functions are optimized. In this step, the structure of the flexible neural network is advantageously fixed and is not changed. The flexible neural network advantageously has the optimized structure from the preceding step 130-2. The parameters of a respective fuzzy membership function formulate a parameter vector. The parameters of the fuzzy membership functions are optimized by locally searching for the optimum of the parameter vectors.

Step 130-3 is advantageously carried out repeatedly until a termination criterion is reached. A termination criterion is for example the reaching of a maximum number of local searches or the reaching of a number of searches or of a time period in which no improved parameter vector of the membership functions is found.

By carrying out the learning method 130, an optimized flexible neural network 300-opt having an optimized structure and optimized parameters is determined.

If, following the performance of step 130-3, a satisfying solution, namely, an optimized flexible neural network 300-opt was determined, learning method 130 is stopped. If a satisfying solution has not yet been found, step 130-2 and subsequently step 130-3 may be performed repeatedly.

Method 100 furthermore comprises a step 140 for deriving 140 criticality values of fuzzy basic events 220 from the optimized flexible neural network 300-opt. The criticality values of the fuzzy basic events 220 of the given fuzzy fault tree 200 are derived from the number of the fuzzy basic events of the optimized flexible neural network 300-opt.

The criticality value for a respective fuzzy basic event is normalized using the optimized parameter of the second level of the respective fuzzy basic event.

The criticality value is explained below in exemplary fashion with reference to the optimized neural network 300-opt of FIG. 2b.

The optimized neural network 300-opt was optimized on the basis of method 100 by application of the learning method. The learning method comprises the optimization on two levels. On the first level, the structure is optimized. On the second level, the parameter values are optimized.

From the structure of the optimized neural network 300-opt, the following numbers for the fuzzy basic events may be ascertained:

x1: 6

x2: 4

x3: 4.

Exemplary optimized parameter values of the fuzzy membership functions are given by:

For the six x1 fuzzy basic events: 3, 5, 1, 9, 1, 4,

For the four x2 fuzzy basic events: 2, 4, 1, 2

For the four x3 fuzzy basic events: 3, 6, 8, 8

This yields the following normalized criticality values:

For x1: 6/(3+5+1+9+4)=6/22

For x2: 4/(2+4+1+2)=4/9

For x3: 4/(3+6+8+8)=4/25

On the basis of the criticality values, the criticality of the technical system may be interpreted as follows:

Min (x1, x2, x3)=min (6/22, 4/9, 4/25)

It follows from this that the fuzzy basic event x3 is the most critical element of the technical system.

The described method 100 may be used in an embedded environment of a technical system for establishing and/or checking functionalities of the technical system.

Furthermore, the described method may be used for developing a technical system in the development phase.

What is claimed is:

1. A computer-implemented method for determining criticality values of a technical system, the method comprising the following steps:
specifying a reliability of the technical system that is to be satisfied;
providing a fuzzy fault tree for the technical system, the fuzzy fault tree including a fuzzy top event, multiple fuzzy basic events, and logical, programmable fuzzy AND/OR operators;
transforming the fuzzy fault tree into a flexible neural network including a tree structure;
determining an optimized flexible neural network by carrying out a learning method for optimizing the flexible neural network, the optimized flexible neural network achieving the reliability of the technical system that is to be satisfied; and
deriving criticality values of the fuzzy basic events from the optimized flexible neural network.

2. The computer-implemented method as recited in claim 1, wherein the learning method includes a first level for optimizing the structure of the flexible neural network.

3. The computer-implemented method as recited in claim 2, wherein an optimization is determined based on a fitness function of fuzzy redundancy functions of the fuzzy fault tree.

4. The computer-implemented method as recited in claim 1, wherein the learning method includes a second level for optimizing parameters of fuzzy membership functions.

5. The computer-implemented method as recited in claim 1, wherein at least one step of the learning method, including steps for optimizing the structure of the neural network and/or steps for optimizing parameters of fuzzy membership functions, are based on a heuristic method.

6. The computer-implemented method as recited in claim 5, wherein, I the heuristic method is an embedded simulated annealing method.

7. The computer-implemented method as recited in claim 4, wherein steps for optimizing the parameters of the fuzzy membership functions include execution of an optimization algorithm.

8. The computer-implemented method as recited in claim 5, wherein the optimization of the structure of the flexible neural network and/or the optimization of the parameters of the membership function are executed repeatedly until a termination criterion is met.

9. The computer-implemented method as recited in claim 8, wherein a termination criterion is given by reaching or exceeding a specific number of iterations or by expiration of a specifiable period of time or by reaching an optimization.

10. The computer-implemented method as recited in claim 5, wherein the optimization of the structure of the flexible neural network and the optimization of the parameters of the fuzzy membership functions are executed repeatedly in alternation.

11. The computer-implemented method in claim 1, wherein the derivation of criticality values of the fuzzy basic events from the optimized flexible neural network occurs based on the a number of the fuzzy basic events of the optimized flexible neural network normalized with the optimized parameter of a second level of the respective fuzzy basic event.

12. A non-transitory computer-readable storage medium on which is stored a computer program including computer-readable instructions for determining criticality values of a technical system, the instructions, when executed by a computer, causing the computer to perform the following steps:
specifying a reliability of the technical system that is to be satisfied;
providing a fuzzy fault tree for the technical system, the fuzzy fault tree including a fuzzy top event, multiple fuzzy basic events, and logical, programmable fuzzy AND/OR operators;
transforming the fuzzy fault tree into a flexible neural network including a tree structure;
determining an optimized flexible neural network by carrying out a learning method for optimizing the flexible neural network, the optimized flexible neural network achieving the reliability of the technical system that is to be satisfied; and
deriving criticality values of the fuzzy basic events from the optimized flexible neural network.

13. The computer-implemented as recited in claim 1, wherein the method is used in an embedded environment of the technical system for establishing and/or checking functionalities of the technical system, and/or is used for developing a technical system.
